(19) United States
(12) Patent Application Publication
(10) Pub. No.: US 2004/0097604 A1
(43) Pub. Date: May 20, 2004

(54) Rigid foams with improved insulation properties and a process for the production of such foams

(76) Inventors: Steven L. Schilling, Pittsburgh, PA (US); Herman P. Doerge, Pittsburgh, PA (US); Edward E. Ball, Weirton, WV (US)

Correspondence Address: BAYER POLYMERS LLC, 100 BAYER ROAD, PITTSBURGH, PA, 15205, US

(21) Appl. No.: 10/295,315

(22) Filed: Nov. 15, 2002

(51) Int. Cl. C08J 9/00

(52) U.S. Cl. 521/50

(57) ABSTRACT

Rigid foams having improved insulation properties are made by reacting a polyisocyanate with an isocyanate-reactive material in the presence of a blowing agent mixture composed of from about 5 to about 50 parts by weight of HFC-134a and from about 50 to about 95 parts by weight of HFC-245fa.

### BACKGROUND OF THE INVENTION

The present invention relates to a process for producing rigid foams with good insulation characteristics (as measured by k-factor) and small cell size and to the foams produced by this process.

Rigid polyurethane foams and processes for their production are known. Such foams are typically produced by reacting an isocyanate with an isocyanate-reactive compound such as a polyol in the presence of a blowing agent.

Among the blowing agents considered to be alternatives to the chlorofluorocarbons (CFCs) and the hydrogen-containing chlorofluorocarbons (HCFCs) which have been or are in the process of being phased out, are the hydrogen containing fluorocarbons referred to as “HFCs”. 1,1,1,3,3-pentafluoropropane (HFC-245fa) and 1,1,1,2-tetrafluoroethane (HFC-134a) are considered to be the most likely HFC replacements for the commonly used 1,1-dichloro-1-fluoroethane (HCFC-141b) which is being phased out.

However, each of these HFC blowing agents has its disadvantages. HFC-245fa produces foams with good k-factors and is easy to handle but it is expensive and its high molecular weight makes it necessary to use it in larger quantities than other blowing agents. HFC-134a is less expensive than HFC-245fa and has a lower molecular weight than HFC-245fa. Consequently, HFC-134a can be used in smaller amounts than HFC-245fa. However, because of its low boiling point (−26° C.), HFC-134a is difficult to handle and higher water levels are often needed to obtain low foam densities. As a result of this higher water level and the higher thermal conductivity of HFC-134a, foams blown with HFC-134a have higher k-factors (i.e., less insulation value) than foams made with HFC-245fa.

It would therefore be advantageous to develop a blowing agent which is less expensive than HFC-245fa, is easy to handle, can be used in smaller amounts than HFC-245fa alone and which gives the good insulation properties (k-factors) of foams made with HFC-245fa alone.

U.S. Pat. No. 6,043,291 teaches that it is difficult to produce polyurethane foams with a uniform cell size using only HFC-245fa or HFC-245fa and water as the blowing agent. The solution to this problem taught in U.S. Pat. No. 6,043,291 is a blowing agent mixture which includes from 20 to 99 parts by weight of HFC-245fa and from 1 to 80 parts by weight of HFC-134a and up to 50 wt % (based on total blowing agent) of other fluorocarbon or HFC blowing agents, excluding water, or from 1 to 20 wt % (based on total blowing agent) of C₃-C₆ hydrocarbon blowing agent, excluding water. U.S. Pat. No. 6,043,291 does not, however, disclose the actual cell sizes of foams produced therein. Nor are the foam cell sizes relative to the cell sizes of foams made with HFC-134a or HFC-245fa alone disclosed. Further, U.S. Pat. No. 6,043,291 does teach that foams made with the disclosed blowing agent combination have good thermal insulating properties (i.e., thermal conductivities of from 0.0150 to 0.0165 kcal/mhr° C.) but it does not disclose the specific thermal conductivity of any given foam or at what temperature these measurements are made. Nor is the thermal conductivity of foams made with the disclosed mixtures discussed in terms relative to foams made with HFC-245fa alone. All that can be learned from this patent concerning k-factor is that the foams made with the disclosed blowing agent have lower k-factors than those made with HFC-134a alone, which is to be expected in view of the lower thermal conductivity of HFC- 245fa.

U.S. Pat. No. 6,086,788 discloses a blowing agent composition for the production of polyurethane and polyisocyanurate closed-cell foams with improved k-factor. The disclosed blowing agent composition is a hydrofluorocarbon selected from HFC-245fa, HFC-134a, HFC-134 and mixtures thereof. An additive selected from alpha-methyl styrene, isobutanol, isopropanol and mixtures thereof is included either in the blowing agent composition or in the component of the foam-forming mixture in which the blowing agent is incorporated or to which the blowing agent is added. The blowing agent additive is included in the blowing agent composition to reduce vapor pressure, improve k-factor, enhance the solubility of the blowing agent in the premix and/or improve processing characteristics. Specific mixtures in which more than one HFC is employed as the blowing agent are not disclosed in this patent. Nor is there any teaching in this patent which would indicate that use of mixtures of the required HFCs would be advantageous for any reason.

U.S. Pat. No. 5,883,142 discloses silicone surfactant cell stabilizers useful for the production of rigid polyurethane foams blown with a C₁-C₄ HFC or HCFC blowing agent. This patent teaches that the silicone surfactant cell stabilizers provide foams with higher closed cell contents and lower k-factors than the silicone surfactants traditionally used to produce rigid polyurethane foams. Use of mixtures of HFC and HCFC blowing agents is not suggested.

To date, however, mixtures of HFC blowing agents which are capable of producing rigid polyurethane/polyisocyanurate foams having the combined properties of small cell size, good k-factor, decreased cost, and ease of processing without the use of special additives or one of a select group of surfactants are not known to those skilled in the art.

### SUMMARY OF THE INVENTION

It is an object of the present invention to provide a process for the production of rigid foams having small cells and improved insulation properties.

It is also an object of the present invention to provide a blowing agent mixture for use in the production of rigid polyurethane foams which has the advantages of HFC-245fa and HFC-134a without the disadvantages.

It is another object of the present invention to provide rigid foams having a thermal conductivity, as measured by k-factor, comparable to that of rigid foams produced using HFC-245fa alone as the blowing agent.

It is a further object of the present invention to provide a blowing agent composition which produces rigid polyurethane foams having average cell sizes smaller than those of foams produced from the same polyurethane-forming reaction mixture that have been blown using only HFC-245fa alone.

These and other objects which will be apparent to those skilled in the art are accomplished by reacting an organic isocyanate with an isocyanate-reactive compound in the presence of a blowing agent composition which includes from 5 to 50 parts by weight of HFC-134a and from 50 to 95 parts by weight of HFC-245fa.

### DETAILED DESCRIPTION OF THE PRESENT INVENTION

The present invention relates to a blowing agent mixture, to a rigid foam having a smaller average cell size than that of a rigid foam produced using only HFC-245fa alone, prefereably those produced using either HFC-245fa or HFC-134a alone, and a thermal conductivity as measured by k-factor similar to that obtained using HFC 245fa alone as the blowing agent, and to a process for the production of those foams.

The blowing agent composition of the present invention includes from 5 to 50 parts by weight, preferably from about 10 to 50 parts by weight, most preferably from about 20 to 40 parts by weight (based on the total weight of the blowing agent mixture) of HFC-134a and from 50 to 95 parts by weight, preferably from about 50 to 90 parts by weight, most preferably from about 60 to 80 parts by weight (based on the total weight of the blowing agent mixture) of HFC-245fa. A minor amount (i.e., less than 10% by weight, based on total weight of blowing agent mixture) of any of the other known blowing agents may optionally be included in the blowing agent mixture of the present invention. The blowing agent mixture of the present invention is generally included in the foam-forming mixture in an amount of from 5 to 20% by weight, preferably from 7 to 18% by weight, based on the total weight of the foam-forming mixture.

Water may also optionally be included in the blowing agent mixture of the present invention. If used, water is generally included in an amount of up to 2% by weight, preferably from about 0.2 to about 1.0% by weight, based on the total weight of the foam-forming mixture.

The blowing agents useful in the present invention include 1,1,1,3,3-pentafluoropropane (HFC-245fa) and 1,1,1,2-tetrafluoroethane (HFC-134a). Each of these blowing agents is known to those skilled in the art and is commercially available.

As is known in the art, rigid foams are prepared by reacting polyisocyanates with isocyanate-reactive compounds. Any of the known organic polyisocyanates may be used in the present invention. Suitable polyisocyanates include: aromatic, aliphatic and cycloaliphatic polyisocyanates and combinations thereof. Representative of these types are diisocyanates such as m- or p-phenylene diisocyanate, toluene-2,4-diisocyanate, toluene-2,6-diisocyanate, hexamethylene-1,6-diisocyanate, tetramethylene-1,4-diisocyanate, cyclohexane-1,4-diisocyanate, isomers of hexahydrotoluene diisocyanate, naphthylene-1,5-diisocyanate, 1-methylphenyl-2,4-phenyl diisocyanate, diphenylmethane-4,4′-diisocyanate, diphenylmethane-2,4′-diisocyanate, 4,4′-biphenylene diisocyanate, 3,3′-methoxy-4,4′-biphenylene diisocyanate and 3,3′-dimethyldiphenylpropane-4,4′-diisocyanate; triisocyanates such as toluene-2,4,6-triisocyanate and polyisocyanates such as 4,4′-dimethyldiphenylmethane-2,2′, 5,5′-tetraisocyanate and the diverse polymethylene polyphenyl polyisocyanates.

A crude polyisocyanate may also be used in making polyurethanes, such as the crude toluene diisocyanate obtained by the phosgenation of a mixture of toluene diamines or the crude diphenylmethane diisocyanate obtained by the phosgenation of crude diphenylmethane diamine.

Especially preferred for making rigid polyurethanes are methylene-bridged polyphenyl polyisocyanates and prepolymers of methylene-bridged polyphenyl polyisocyanates, having an average functionality of from about 1.8 to about 3.5, preferably from about 2.0 to about 3.1, most preferably from about 2.5 to 3.0 isocyanate moieties per molecule and an NCO group content of from about 28 to about 34% by weight, preferably from about 28 to about 32% by weight, due to their ability to crosslink the polyurethane. The isocyanate index (ratio of equivalents of isocyanates to equivalents of active hydrogen-containing groups) is advantageously from about 0.9 to about 3.0, preferably from about 1.0 to about 2.0 and most preferably from about 1.0 to about 1.5.

Any of the known isocyanate reactive organic compounds may be used to produce foams in accordance with the present invention. Polyols or mixtures of polyols containing an average of at least two, preferably from about 3 to about 5, most preferably from about 3.5 to about 4.5 isocyanate-reactive hydrogen atoms and having a hydroxyl (OH) number of from about 200 to about 650 (preferably from about 350 to about 470) are particularly preferred isocyanate-reactive compounds useful in the practice of the present invention. The molecular weight of such isocyanate-reactive materials is determined from the functionality and equivalent weight determined by the end group analysis method generally used by those skilled in the art and represents a number average molecular weight.

Polyols with suitable functionality and molecular weight may be prepared by reacting a suitable initiator containing active hydrogens with alkylene oxide. Suitable initiators are those containing at least 3 active hydrogens or mixtures of initiators where the mole average of active hydrogens is at least 3, preferably from about 4 to about 8, and more preferably from about 4 to about 6. Active hydrogens are defined as those hydrogens which are observed in the well-known Zerewitinoff test. (See Kohler, Journal of the American Chemical Society, p. 3181, Vol. 49 1927). Representatives of such active hydrogen-containing groups include —OH, COOH, —SH and —NHR where R is H or alkyl, aryl aromatic group and the like.

Examples of suitable initiators include pentaerythritol, carbohydrate compounds such as lactose, α-methylglucoside, α-hydroxyethylglucoside, hexitol, heptitol, sorbitol, dextrose, mannitol, sucrose and the like, ethylene diamine and alkanol amines. Examples of suitable aromatic initiators containing at least four active hydrogens include aromatic amines such as isomers of toluene diamine, particularly ortho-toluene diamine, and methane diphenylamine, the reaction product of a phenol with formaldehyde, and the reaction product of a phenol with formaldehyde and a dialkanolamine such as those described in U.S. Pat. Nos. 3,297,597; 4,137,265 and 4,383,102. Other suitable initiators which may be used in combination with the initiators containing at least four active hydrogens include water, glycols, glycerine, trimethylolpropane, hexane triol, aminoethyl piperazine and the like. These initiators may contain less than four active hydrogens and therefore can only be employed in quantities such that the total mole average of active hydrogens per molecule remains at least about 3. Particularly preferred initiators for the preparation of the high functionality, high molecular weight polyols include sucrose, sorbitol, α-methylglucoside, toluene diamine, and ethylene diamine which may be employed separately or in combination with other initiators such as glycerine, glycols or water.

The polyols may be prepared by methods well known in the art such as those taught by Wurtz, The Encyclopaedia of Chemical Technology, Vol. 7, p. 257-266, lnterscience Publishers Inc. (1951) and U.S. Pat. No. 1,922,459. For example, polyols can be prepared by reacting, in the presence of an oxyalkylation catalyst, an initiator with an alkylene oxide. A wide variety of oxyalkylation catalysts may be employed, if desired, to promote the reaction between the initiator and the alkylene oxide. Suitable catalysts include those described in U.S. Pat. Nos. 3,393,243 and 4,595,743. However, it is preferred to use as a catalyst a basic compound such as an alkali metal hydroxide, e.g., sodium or potassium hydroxide, or a tertiary amine such as trimethylamine. The reaction is usually carried out at a temperature of from about 60° C. to about 160° C., and is allowed to proceed using a ratio of alkylene oxide to initiator such that a polyol having a hydroxyl number ranging from about 200 to about 650, preferably about 300 to about 550, most preferably from about 350 to about 500 is obtained. The hydroxyl number range of from about 200 to about 650 corresponds to an equivalent weight range of from about 280 to about 86.

Polyols of a higher hydroxyl number than 650 may be used as optional ingredients in the process of the present invention. Amine-based polyols having OH values greater than 650, preferably greater than 700 are particularly useful as optional ingredients.

The alkylene oxides which may be used in the preparation of the polyol include any epoxide or α,β-oxirane, and are unsubstituted or alternatively substituted with inert groups which do not chemically react under the conditions encountered during preparation of a polyol. Examples of suitable alkylene oxides include ethylene oxide, propylene oxide, 1,2- or 2,3-butylene oxide, the various isomers of hexane oxide, styrene oxide, epichlorohydrin, epoxychlorohexane, epoxychloropentane and the like. Most preferred, on the basis of performance, availability and cost are ethylene oxide, propylene oxide, butylene oxide and mixtures thereof, with ethylene oxide, propylene oxide, or mixtures thereof being most preferred. When polyols are prepared with combinations of alkylene oxides, the alkylene oxides may be reacted as a complete mixture providing a random distribution of oxyalkylene units within the alkylene oxide chain of the polyol or alternatively they may be reacted in a stepwise manner so as to provide a block distribution within the oxyalkylene chain of the polyol.

The polyamines useful as polyol initiators in the practice of the present invention may be prepared by any of the known methods. For example, via the nitration of an aromatic hydrocarbon with nitric acid followed by reduction, as in the preparation of toluene diamine (TDA), or via the reaction of ammonia with epoxides to obtain alkanol amines, such as ethanol amine, or via the condensation reaction of aldehydes with aromatic amines such a aniline to produce methylene bridged polyphenylpolyamines (polymeric methylene dianiline, otherwise known as MDA).

Suitable optional polyols include polyether polyols, polyester polyols, polyhydroxy-terminated acetal resins, hydroxy-terminated amines and polyamines. Examples of these and other suitable materials are described more fully in U.S. Pat. No. 4,394,491. Most preferred for preparing rigid foams are those having from about 2 to about 6 active hydrogens and having a hydroxyl number from about 50 to about 800, preferably from about 100 to about 650, and more preferably from about 200 to about 550. Examples of such polyols include those commercially available under the product names Terate (available from KoSa Corporation) and Multranol (available from Bayer Corporation).

Other components useful in producing the polyurethanes of the present invention include surfactants, pigments, colorants, fillers, antioxidants, flame retardants, stabilizers, and the like.

When preparing polyisocyanate-based foams, it is generally advantageous to employ a minor amount of a surfactant to stabilize the foaming reaction mixture until it obtains rigidity. Such surfactants advantageously comprise a liquid or solid organosilicon compound. Other, less preferred surfactants include polyethylene glycol ethers of long chain alcohols, tertiary amine or alkanolamine salts of long chain alkyl acid sulfate esters, alkylsulfonic esters, and alkylarylsulfonic acids. Such surfactants are employed in amounts sufficient to stabilize the foaming reaction mixture against collapse and the formation of large, and uneven cells. Typically, about 0.2 to about 5.0 parts of the surfactant per 100 parts per weight polyol composition are sufficient for this purpose.

One or more catalysts are advantageously used to produce foams in accordance with the present invention. Any suitable urethane catalyst may be used including any of the known tertiary amine compounds or organometallic compounds. Examples of suitable tertiary amine catalysts include triethylenediamine, N-methylmorpholine, pentamethyl diethylenetriamine, dimethylcyclohexylamine, tetramethylethylenediamine, 1-methyl-4-dimethylaminoethyl-piperazine, 3-methoxy-N-dimethyl-propylamine, N-ethylmorpholine, diethylethanolamine, N-cocomorpholine, N,N-dimethyl-N′,N′-dimethylisopropyl-propylene diamine, N,N-diethyl-3-diethyl aminopropyl amine and dimethyl-benzyl amine. Examples of suitable organometallic catalysts include organomercury, organolead, organoferric and organotin catalysts, with organotin catalysts being preferred. Suitable organotin catalysts include tin salts of carboxylic acids such as dibutyltin di-2-ethyl hexanoate and dibutyltin dilaurate. Metal salts such as stannous chloride can also function as catalysts for the urethane reaction. A catalyst for the trimerization of polyisocyanates, such as an alkali metal alkoxide or carboxylate, may also optionally be employed. Such catalysts are used in an amount which measurably increases the rate of reaction of the polyisocyanate. Typical amounts are about 0.01 to about 3 part of catalyst per 100 parts by weight of polyol.

The components described may be employed to produce rigid polyurethane and polyurethane-modified isocyanurate foams. The rigid foams of the present invention may be made in a one-step process by reacting all of the ingredients together at once, or foams can be made by the so-called “quasi prepolymer” method. In the one-shot process where foaming is carried out using machines, the active hydrogen containing compounds, catalyst, surfactants, blowing agents and optional additives may be introduced separately to the mixing head where they are combined with the polyisocyanate to give the polyurethane-forming mixture. The mixture may be poured or injected into a suitable container or molded as required. For use of machines with a limited number of component lines into the mixing head, a premix of all the components except the polyisocyanate can be advantageously employed. This simplifies the metering and mixing of the reacting components at the time the polyurethane-forming mixture is prepared.

Alternatively, the foams may be prepared by the so-called “quasi-prepolymer” method. In this method, a portion of the polyol component is reacted in the absence of catalyst with the polyisocyanate component in a proportion such that from about 10 percent to about 30 percent free isocyanate groups are present in the prepolymer. To prepare foam, the remaining portion of the polyol is added to the prepolymer and the components are allowed to react together in the presence of a catalyst and other appropriate additives such as the blowing agent, surfactant, etc. Other additives may be added to either the isocyanate prepolymer or remaining polyol or both prior to the mixing of the components to produce a rigid polyurethane foam.

The foams of the present invention are characterized by small cells and improved insulation properties. The foams of the present invention have an average cell size which is smaller than the average cell size of foams produced from the same isocyanate and isocyanate-reactive components with only HFC-245fa or HFC-134a as the blowing agent. The foams of the present invention are also characterized by k-factors comparable to those of rigid foams produced using only HFC-245fa as the blowing agent. As used herein, a k-factor which is ±5%, preferably ±3%, of the k-factor of a foam blown with only HFC-245fa, is considered to be comparable to a rigid foam produced using only HFC-245fa.

The polyurethane foams of this invention are useful in a wide range of applications. Accordingly, not only can rigid appliance foams be prepared but spray insulation, rigid insulating board stock, laminates and many other types of rigid foam can easily be prepared according to this invention.

The following Examples are given as being illustrative of the present invention. All parts and percentages given in these Examples are parts by weight and percentages by weight, unless otherwise indicated.

### EXAMPLES

The following materials were used in the Examples which follow:

POLYOL: A blend made up of (1) 55% by weight (based on total weight of POLYOL blend) of a sucrose/water/ethylene oxide/propylene oxide adduct having a functionality of about 5.2 and an OH number of about 470 mg KOH/g; (2) 25% by weight (based on total weight of POLYOL blend) of an o-toluenediamine/ethylene oxide/propylene oxide adduct having a functionality of 4 and an OH number of about 388 mg KOH/g; and (3) 20% by weight (based on total weight of POLYOL blend) Stepanpol PS-2502A, an aromatic polyester polyol having a functionality of 2 and an OH number of about 240 which is commercially available from Stepan Company.

SURFACTANT: A silicone surfactant which is commercially available from Air Products and Chemicals Inc. under the designation DC-5357.

CATALYST A: A tertiary amine catalyst which is commercially available from Rhein Chemie Corporation under the name Desmorapid PV.

CATALYST B: A strongly basic, amber-brown liquid having a characteristic amine odor which is commercially available from Air Products under the designation Polycat 41.

HFC-245fa: 1,1,1,3,3-pentafluoropropane.

HFC-134a: 1,1,1,2-tetrafluoroethane.

ISO: A modified polymethylene polyphenyl polyisocyanate prepolymer blend having an NCO group content of 30.2% which is a 1:1 blend of the isocyanates which are commercially available from Bayer under the names Mondur MR and Mondur MRP.

### Examples 1-4

POLYOL, SURFACTANT, CATALYST A, CATALYST B, water and blowing agent were combined in the amounts indicated in Table 1. This mixture was then combined with the amount of ISO indicated in Table 1 in the Hennecke MQ-1 2-2 mixhead of an HK 100 high-pressure foam machine. The mixture was then injected into a 120° F. mold made of aluminum measuring 200×20×5 cm (approximately 79×8×2 inches) in which it was allowed to foam and set. The properties of the foam are reported in Table 1. In Table 1, the formulations for Examples 2 and 3 were obtained by combining the formulation for comparative Examples 1 and 4 in ratios of 3:1 and 1:1, respectively.

TABLE 1

Example

| Material | 1* | 2 | 3 | 4* |
|---|---|---|---|---|
| POLYOL (pbw) | 66.72 | 69.09 | 71.47 | 76.22 |
| DC5357 (pbw) | 2.42 | 2.45 | 2.49 | 2.56 |
| PV (pbw) | 1.33 | 1.22 | 1.12 | 0.91 |
| PC-41 (pbw) | 0.66 | 0.61 | 0.56 | 0.46 |
| WATER (pbw) | 0.80 | 0.95 | 1.10 | 1.39 |
| HFC-134a | — | 4.61 | 9.23 | 18.46 |
| (pbw) | | | | |
| HFC-245fa | 28.07 | 21.05 | 14.04 | — |
| (pbw) | | | | |
| ISO. (pbw) | 93.4 | 97.1 | 100.7 | 107.9 |
| Overall Foam | 2.09 | 2.23 | 2.28 | 2.43 |
| Density, lbs/ft³ | | | | |
| k-Factor @ | 0.116 | 0.116 | 0.117 | 0.125 |
| 35° F., Btu-in./ | | | | |
| hr · ft² ° F. | | | | |
| k-Factor A | 0.131 | 0.132 | 0.133 | 0.141 |
| 75° F., Btu-in./ | | | | |
| hr · ft² ° F. | | | | |
| Average Cell | 109 | 104 | 86 | 96 |
| Diameter, μm | | | | |

*Comparative Example

It is evident from the data presented in the Table, that the foams made with the blowing agent composition of the present invention had a k-factor comparable to that of the foam blown with only HFC-245fa. The foam of Example 3 in which HFC-134a and HFC-245fa were used in a 1:1 ratio had a smaller average cell diameter than both the foam blown with only HFC-134a and the foam blown with only HFC-245fa. The unexpectedly good k-factor obtained for the foam produced in accordance with the present invention was achieved using a smaller amount of the expensive blowing agent HFC-245fa. The significantly smaller average cell size of the foam of the present invention relative to the foams made with only HFC-245fa and preferably also HFC-134a also contributes to the good insulation properties of the foam.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the production of a rigid foam comprising reacting
a) an organic isocyanate
with
b) an isocyanate reactive compound
in the presence of
c) a blowing agent mixture comprising
(1) from about 5 to about 50 parts by weight, based on the total weight of c) of HFC-134a and
(2) from about 50 to about 95 parts by weight, based on the total weight of c) of HFC-245fa
to produce a rigid foam having (i) a k-factor comparable to that of a foam produced by reacting a) and b) in the presence of only HFC-245fa and (ii) an average cell size smaller than that of a foam produced by reacting a) and b) in the presence of only HFC-245fa.

2. The process of claim 1 in which blowing agent mixture c) comprises
(1) from 15 to 40 parts by weight, based on the total weight of c) of HFC-134a and
(2) from 60 to 85 parts by weight, based on the total weight of c) of HFC-245fa.

3. The process of claim 1 in which up to 2% by weight, based on the total weight of foam-forming mixture, of water is included in blowing agent c).

4. The process of claim 1 in which the isocyanate a) is a polymethylene polyphenyl polyisocyanate.

5. The process of claim 1 in which the isocyanate reactive compound b) is a polyol or polyol mixture having an hydroxyl number of from about 200 to about 650 mg KOH/g.

6. A blowing agent composition comprising
a) from about 5 to about 50 parts by weight of HFC-134a and
b) from about 50 to about 95 parts by weight of HFC-245fa.

7. The blowing agent of claim 6 comprising
a) from about 15 to about 40 parts by weight of HFC-134a and
b) from about 60 to about 85 parts by weight of HFC-245fa.

8. A rigid polyurethane foam produced by the process of claim 1.
